(19) United States
(12) Patent Application Publication
(10) Pub. No.: US 2026/0235505 A1
(43) Pub. Date: Aug. 13, 2026

(54) METHOD TO MEASURE TURBIDITY AND TOTAL SUSPENDED SOLIDS AND TURBIDITY SENSOR SYSTEM THEREOF

(71) Applicant: Haber Inc., Naperville, IL (US)

(72) Inventors: Vipin Raghavan, Kannur (IN); Arjunan P N, Rangareddy (IN); Claudy D'Costa, Pune (IN); Priyadarshini V., Bangalore (IN); Swathy Chandra, Pune (IN)

(21) Appl. No.: 19/534,588

(22) Filed: Feb. 9, 2026

Related U.S. Application Data
(60) Provisional application No. 63/756,702, filed on Feb. 10, 2025.

(51) Int. Cl. G01N 21/3577; G01N 21/359

(52) U.S. Cl. CPC G01N 21/3577; G01N 21/359; G01N 2201/061

(57) ABSTRACT

The present disclosure relates to a turbidity sensor system and a method for measuring turbidity, consistency, and total suspended solids in a liquid. The method comprising emitting a specific wavelength of a light in a liquid. Thereafter, the method comprises detecting a scattered light via each dedicated channel of the at least two pairs of detectors in response to the specific wavelength of the light emitted in the liquid and converting analog data associated with the scattered light to digital data for each dedicated channel of the at least two pairs of detectors. Subsequently, the method comprises segregating the digital data into a plurality of clusters using a clustering technique. Lastly, the method comprises measuring at least one parameter related to turbidity of the liquid based on the plurality of clusters and a tree-based technique.

### FIELD OF INVENTION

The present disclosure relates to turbidity sensing, more particularly, but not exclusively, to a method and a turbidity sensor system to measure turbidity, consistency, and total suspended solids of a liquid.

### BACKGROUND

There are multiple technologies that currently exists to measure the Total Suspended Solids (TSS) and the Turbidity (TRB) of liquids. One of the early technologies of measuring TRB or TSS are using gravimetric analysis sensors. In this method, a quantitative determination of a sample was carried out based on its mass. This process is highly time-consuming and labour-intensive. Then, there are acoustic sensors that gave results based on reflection from sound waves. However, use of acoustic sensors had high error in case of highly turbid water.

Among different technologies for the TSS or TRB measurement, the most prominent techniques are nephelometers or turbidimeters. These techniques work under the standard procedure of United States Environmental Protection Agency (USEPA) Method 180.1, where a light sent through a light source gets scattered by suspended particles in a (liquid) medium. The scattered light is observed at different angles to an incident ray of light. When the scattered light comes to 90° angle, the method is called nephelometry. This method was later adopted by turbidity probes, where a probe was dipped in to a liquid sample to read-out values. However, this existing technology requires a very high budget. Further, the design and manufacturing of an optical window is very complicated and complex. A transparent window (made of sapphire) is fused bonded with a metal part with very tight tolerances. The added challenge is the size of the optical window, which is around 2 mm in diameter. Moreover, in this technique, the data are obtained through complicated analog circuits, which makes the output completely dependent on the electronic circuitry (i.e., hardware) within the sensor. This limits the user's ability to completely analyse the data and use it for a better prediction of the TSS and/or TRB of the liquid sample. Additionally, the noise is another problem associated with use of analog circuits. With more analog components on board, the amount of noise in the signal also increases.

The information disclosed in this background of the disclosure section is for enhancement of understanding of the general background of the invention and should not be taken as an acknowledgement or any form of suggestion that this information forms the prior art already known to a person skilled in the art.

### SUMMARY

In an embodiment, the present disclosure relates to a turbidity sensor system for measuring at least one parameter related to turbidity of a liquid. The turbidity sensor system comprising a probe suspended in a liquid. The probe comprises at least two emitters, at least two pairs of detectors, an electronic circuit communicatively connected to the at least two pairs of detectors, and a measuring module communicatively connected to the electronic circuit. Each emitter of the at least two emitters is configured to emit a specific wavelength of a light in the liquid. Each detector of the at least two pairs of detectors is configured to detect a scattered light via each dedicated channel of the at least two pairs of detectors in response to the specific wavelength of the light emitted in the liquid. The electronic circuit is configured to convert analog data associated with the scattered light to digital data for each dedicated channel of the at least two pairs of detectors. The measuring module is configured to segregate the digital data into a plurality of clusters using a clustering technique and measure at least one parameter related to turbidity of the liquid based on the plurality of clusters and a tree-based technique.

In another embodiment, the present disclosure relates to a turbidity sensor system for measuring at least one parameter related to turbidity of a liquid. The turbidity sensor system comprising a probe suspended in a liquid and a measuring module. The probe comprises at least two emitters, at least two pairs of detectors, and an electronic circuit communicatively connected to the at least two pairs of detectors. The measuring module is communicatively connected to the electronic circuit. Each emitter of the at least two emitters is configured to emit a specific wavelength of a light in the liquid. Each detector of the at least two pairs of detectors is configured to detect a scattered light via each dedicated channel of the at least two pairs of detectors in response to the specific wavelength of the light emitted in the liquid. The electronic circuit is configured to convert analog data associated with the scattered light to digital data for each dedicated channel of the at least two pairs of detectors, segment the digital data of each dedicated channel of the at least two pairs of detectors into associated plurality of packets for each dedicated channel, and transmit the associated plurality of packets of each dedicated channel of the at least two pairs of detectors to the measuring module. The measuring module is configured to extract the digital data from the associated plurality of packets, segregate the digital data into a plurality of clusters using a clustering technique, and measure at least one parameter related to turbidity of the liquid based on the plurality of clusters and a tree-based technique.

In an embodiment, the present disclosure relates to a method for measuring at least one parameter related to turbidity of a liquid. The method comprising emitting a specific wavelength of a light in a liquid and detecting a scattered light via each dedicated channel of the at least two pairs of detectors in response to the specific wavelength of the light emitted in the liquid. Thereafter, the method comprises converting analog data associated with the scattered light to digital data for each dedicated channel of the at least two pairs of detectors. Subsequently, the method comprises segregating the digital data into a plurality of clusters using a clustering technique. Lastly, the method comprises measuring at least one parameter related to turbidity of the liquid based on the plurality of clusters and a tree-based technique.

In another embodiment, the present disclosure relates to a method for measuring at least one parameter related to turbidity of a liquid. The method comprising emitting a specific wavelength of a light in the liquid, and detecting a scattered light via each dedicated channel of the at least two pairs of detectors in response to the specific wavelength of the light emitted in the liquid. Thereafter, the method comprises converting analog data associated with the scattered light to digital data for each dedicated channel of the at least two pairs of detectors, and segmenting the digital data of each dedicated channel of the at least two pairs of detectors into associated plurality of packets for each dedicated channel. Subsequently, the method comprises transmitting the associated plurality of packets of each dedicated channel of the at least two pairs of detectors to an estimating measuring module. The method comprises extracting the digital data from the associated plurality of packets, and segregating the digital data into a plurality of clusters using a clustering technique. Lastly, the method comprises measuring at least one parameter related to turbidity of the liquid based on the plurality of clusters and a tree-based technique.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1a illustrates an environment for implementing a turbidity sensor system to measure turbidity, consistency, and total suspended solids in accordance with some embodiments of the present disclosure.

FIG. 1b illustrates a signal pattern incident light, in accordance with some embodiments of the present disclosure.

FIG. 1c illustrates one example configuration of seven optical windows, including the optional reference window arranged in a probe in accordance with some embodiments of the present disclosure.

FIG. 2 illustrates a flow diagram showing a method for measuring turbidity, consistency, and total suspended solids in accordance with an embodiment of the present disclosure.

FIG. 3 illustrates a flow diagram showing a method for measuring turbidity, consistency, and total suspended solids in accordance with another embodiment of the present disclosure.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Consistency is defined as the percentage of dry fibre (i.e., solid matter) present in a pulp-water suspension, expressed by weight in percentage terms. It specifically reflects the fibre concentration in the mixture, rather than the presence of other particulate matter. For example, a pulp suspension with 1% consistency contains 1 gram of dry fibre solids per 100 grams of the total pulp-water mixture. This parameter is critical in pulp and paper processing, as fibre content governs rheology, drainage, and sheet formation properties.

Total Suspended Solids (TSS), by contrast, measures the total mass of undissolved solids present in water, encompassing fibres, fines, fillers, and other insoluble particles. While TSS is a broader measure, in pulp suspensions it is often used interchangeably with consistency because fibres constitute the dominant fraction of solids. For practical purposes in this invention, the following equivalence is established:

$$10 \text{,0} 00 ppm ( TSS ) ≡ 1 \% consistency \qquad ( 1 )$$

This relationship allows consistency to be expressed either in percentage terms or in parts per million (ppm) of TSS, depending on the measurement methodology. Such interchangeability enables users or operators to use standard water-quality instrumentation to infer pulp consistency without requiring fibre-specific sensors.

Turbidity is a related but distinct parameter, representing the optical property of a liquid that causes light to be scattered by suspended particles. It is typically expressed in Nephelometric Turbidity Units (NTU). Turbidity does not directly measure mass concentration but instead provides an indirect indication of the presence and distribution of suspended matter. In pulp suspensions, turbidity correlates with fines, fillers, and colloidal material, which may not significantly affect fibre-based consistency but do influence water clarity and process monitoring. Thus, turbidity serves as a complementary measurement: while consistency and TSS quantify solids by weight, turbidity provides insight into particle size distribution and dispersion characteristics.

From the measured turbidity value, the TSS can be derived using techniques known in the art, such as linear correlation or linear regression techniques established for specific liquid sample types. Once the TSS value has been determined, the consistency of the liquid sample can be obtained by applying the relationship described above in equation (1), which links TSS to consistency. This approach allows indirect estimation of consistency through turbidity measurements, thereby reducing the need for direct consistency testing and enabling more efficient monitoring of process parameters.

By integrating consistency, TSS, and turbidity measurements, the present invention establishes a comprehensive framework for monitoring pulp suspensions. Consistency ensures fibre concentration control, TSS provides a total solids benchmark, and turbidity offers optical feedback on fines and colloidal content. Together, these parameters enable more precise process regulation, improved quality assurance, and enhanced adaptability in industrial pulp and paper applications.

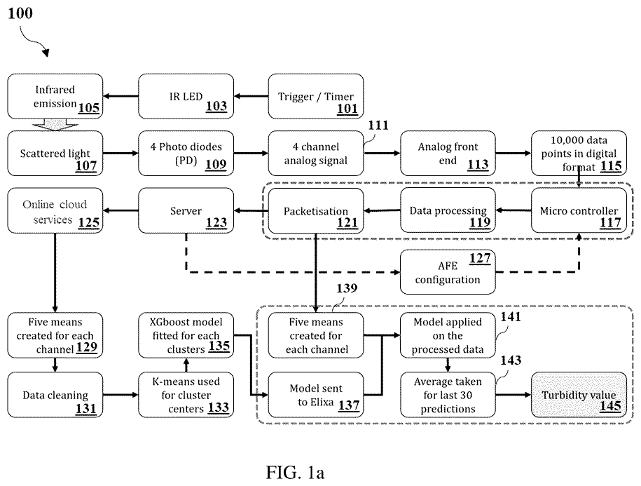

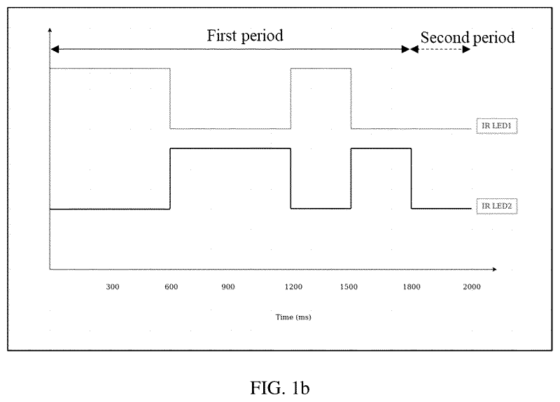

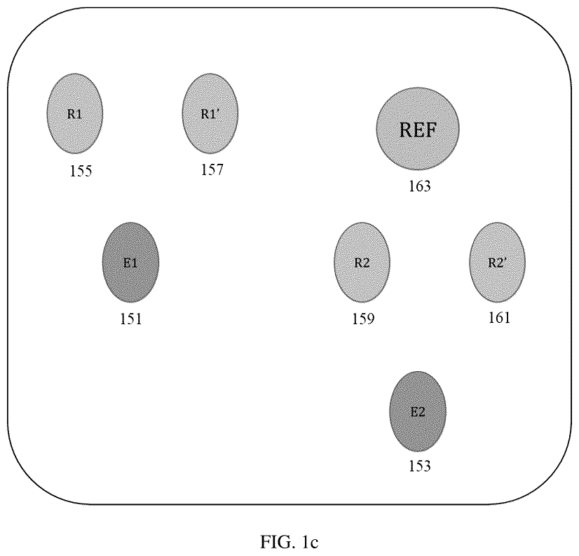

FIG. 1a illustrates an environment for implementing a turbidity sensor system to measure turbidity, consistency, and total suspended solids in accordance with some embodiments of the present disclosure.

The environment or a turbidity sensor system 100 may be constituted by a probe (also, referred as sensor) and a measuring module. The probe comprises a trigger circuit (also, referred as timer) 101, at least two emitters (also, referred as IR LED) 103, at least two pairs of detectors 109, and an electronic circuit. In one embodiment, the measuring module is integrated within the probe. In another embodiment, the measuring module is positioned externally, such that it is not part of the probe but communicatively connected thereto. The probe (not shown in FIG. 1a) is suspended in a liquid whose at least one of turbidity, consistency, or total suspended solids is to be measured or estimated. In one embodiment, the probe comprises an optical window corresponding to each emitter of the at least two emitters 103 and each detector of the at least two pairs of detectors 109. In another embodiment, the probe comprises a reference window in addition to an optical window corresponding to each emitter of the at least two emitters 103 and each detector of the at least two pairs of detectors 109. The presence of the reference window enables compensation for ambient light, thereby reducing interference from external illumination sources and improving the accuracy of measurements obtained by the turbidity sensor system. The liquid comprises suspended particles. The trigger circuit 101 is communicatively connected to the at least two emitters 103. The trigger circuit 101 is configured to trigger one emitter of the at least two emitters to emit a specific wavelength of the light in the liquid. Each emitter of the at least two emitters 103 is configured to emit specific wavelength of a light (also, referred as an incident light). Each emitter of the at least two emitters 103 is a Light Emitting Diode (LED). In an embodiment, the LED is an Infrared (IR) LED 103 with a specific wavelength. The specific wavelength of the light is one of wavelengths from, but not limited to, 800 nm to 1100 nm. Each detector of the at least two pairs of detectors 109 is configured to detect scattered light 107 resulting from the incident light emitted by an associated emitter. In detail, each detector of the at least two pairs of detectors 109 is configured detect the scattered light 107 via each dedicated channel of the at least two pairs of detectors 109 in response to the specific wavelength of the light emitted in the liquid. Each detector of the at least two pairs of detectors 109 is a Photodiode (PD) 109. Each emitter has an associated pair of detectors. By way of example, the present disclosure provides a configuration comprising two emitters and four detectors, wherein each emitter is operatively associated with a corresponding pair of detectors i.e., an associated pair of detectors.

The probe has a metal head of precisely milled holes at a particular angle in which the at least two emitters and the at least two pairs of detectors are placed or positioned. Each emitter of the at least two emitters 103 is configured to send or transmit a light (i.e., incident light) into the liquid. Each detector of the at least two pairs of detectors 109 is configured to detect scattered light 107 resulting from particle scattering of incident light emitted by an associated emitter, the detection occurring through a high-precision optical window (not shown in FIG. 1a). The optical window facilitates emission and reception of light from the at least two emitters and at least two pairs of detectors, respectively. The optical window is made from, but not limited to, sapphire to ensure enough strength and minimal scratches when put in high turbid liquid (or solution). The probe is made of a stainless steel material with IP68 rating for protection against water and dust. The size and shape of the probe is designed for smooth integration with industrial connectors and flanges. The casing or body of the probe is functionally required to enclose the at least two emitters 103, the at least two pairs of detectors 109, the associated electronic circuit and components, as well as the optical window and/or reference window. The body of the probe ensures hermetic sealing and can be submerged to up to 40 m under water. The optical window and/or reference window is arranged at the end of the probe on a flat plate which can be of any shape as long as the window is contained on the same plane. The end/flat plate can be placed perpendicular or at an angle to a cylindrical body of the probe. In one embodiment, an optional mechanical cleaning mechanism is provided to maintain the visibility of the optical windows and to prevent fouling or accumulation of contaminants thereon. For the mechanical cleaning mechanism, the probe includes a wiper with a motor and gear assembly to keep the optical window clean from any obstacles so that the light can travel through the optical window and/or reference window without any hindrance. By way of example, the end or flat plate of the probe can be configured to accommodate up to seven optical windows or elements, including an optional reference window. The remaining six optical windows may be individually configured to function as optical windows, arranged in various configurations, or alternatively combined beneath a single large optical window. One example configuration of seven optical windows, including the optional reference window arranged in the probe is shown in FIG. 1c.

The electronic circuit of the probe is communicatively connected to the at least two pairs of detectors 109. In one embodiment, the electronic circuit comprises an Analog Front End (AFE) circuit 113 and a microcontroller 117. In the embodiment where the measuring module is integrated within the probe, the electronic circuit does not include a packetization module (i.e., packetisation) 121. In this case, the electronic circuit is configured to convert analog data 111 associated with the scattered light 107 to digital data 115 for each dedicated channel of the at least two pairs of detectors 109. In contrast, in the embodiment where the measuring module is positioned externally and is not part of the probe, the electronic circuit further comprises a packetization module 121, as shown in FIG. 1a. In this case, the electronic circuit is configured to convert analog data 111 associated with the scattered light 107 to digital data 115 for each dedicated channel of the at least two pairs of detectors 109, segment the digital data 115 of each dedicated channel of the at least two pairs of detectors 109 into associated plurality of packets for each dedicated channel, and transmit the associated plurality of packets of each dedicated channel of the at least two pairs of detectors 109 to the measuring module.

In the embodiment where the measuring module is integrated within the probe, the measuring module is communicatively connected to the electronic circuit in a wired manner. In this case, the measuring module is configured to segregate the digital data 115 into a plurality of clusters using a clustering technique and measure at least one parameter related to turbidity 145 of the liquid based on the plurality of clusters and a tree-based technique. In the embodiment, where the measuring module is positioned externally, such that it is not part of the probe, the measuring module and the packetization module 121 of the electronic circuit may employ communication protocols/methods involving a wired or wireless protocol, without limitation, such as Universal Serial Bus (USB), Bluetooth, Wireless Fidelity (Wi-Fi), Ethernet, User Datagram Protocol (UDP), or the like. In this case, the measuring module is configured to receive the associated plurality of packets of each dedicated channel of the at least two pairs of detectors 109 from the electronic circuit, extract the digital data 115 from the associated plurality of packets, segregate the digital data 115 into a plurality of clusters using a clustering technique, and measure at least one parameter related to turbidity 145 of the liquid based on the plurality of clusters and a tree-based technique.

Hereinafter, the method for measuring or estimating at least one parameter related to turbidity of a liquid is explained with reference to FIG. 1a.

In a testing phase, prior to the measurement, the probe of the turbidity sensor system 100 is immersed or suspended in a liquid whose at least one of a turbidity value, consistency, and total suspended solids value of the liquid is to be measured or estimated. The liquid comprises suspended particles. To start the measurement process, the trigger circuit (or timer) 101 of the probe triggers one emitter of the at least two emitters (i.e., IR LED) 103 to emit the specific wavelength of the light (also, referred as Infrared (IR) emission 105) in the liquid. The specific wavelength of the light is one of wavelengths from, but not limited to, 800 nm to 1100 nm. The trigger from the trigger circuit 101 is timed such that only one emitter of the at least two emitters 103 is in ON state during each of cycle for a first period and each emitter of the at least two emitters 103 is in OFF state for a second period i.e., there is a period when both of the at least two emitters (i.e., IR LED1 and IR LED2) are in OFF state, as shown in FIG. 1b. The light (also, referred as incident light) is emitted through the optical window of the probe hit particles in the liquid and get scattered. As per the number of suspended particles in the liquid, the incident light gets scattered to give scattered light 107 in different angles or directions which are detected by the at least two pairs of detectors 109. In detail, each detector of the at least two pairs of detectors 109 detects the scattered light 107 via each dedicated channel of the at least two pairs of detectors 109 in response to the specific wavelength of the light emitted in the liquid. Each detector of the at least two pairs of detectors 109 is a photodiode. Thereafter, the data associated with the scattered light 107 is processed through a series of processing steps to estimate or measure at least one of a turbidity value, consistency, and total suspended solids value in the liquid.

Each detector of the at least two pairs of detectors 109 has a dedicated channel 111 (i.e., 4 channel analog signal) for sending the data associated with the scattered light 107 to AFE circuit (also, referred as AFE) 113 of the electronic circuit for processing. The AFE circuit 113 is an ultra-low-power circuit with a high Signal-to-Noise Ratio (SNR). The data (i.e., analog data) associated with the scattered light 107 is sent to the AFE circuit via the dedicated channel (i.e., 4 channel) 111 by the at least two pairs of detectors 109. The AFE circuit 113 processes or filters the data associated with the scattered light 107 detected via each dedicated channel of the at least two pairs of detectors 109 to obtain noise-free data. Thereafter, the AFE circuit 113 of the electronic circuit converts the analog data (i.e., the noise-free analog data) associated with the scattered light 107 to digital data (i.e., data points in digital format) 115 for each dedicated channel of the at least two pairs of detectors 109. The digital data is received by the microcontroller 117 of the electronic circuit. The microcontroller 117 of the electronic circuit is a, but not limited to, 32-bit microcontroller. The microcontroller 117 of the electronic circuit processes the digital data (i.e., data processing 119) received from the AFE circuit 113 of the electronic circuit. In detail, the microcontroller 117 of the electronic circuit collects 5000 (digital) data points per second from the AFE circuit 113 of the electronic circuit and sorts the digital data from four different channels (i.e., inputs from 4 PDs 109). In an embodiment, the microcontroller 117 of the electronic circuit controls a wiper and a motor attached to the optical windows and/or the reference window of the probe.

In the embodiment where the measuring module is integrated within the probe, the measuring module of the probe segregates the digital data 115 into a plurality of clusters using a clustering technique. In an embodiment, the clustering technique is, not limited to, a K-means clustering technique. The measuring module of the probe measures at least one parameter related to turbidity 145 of the liquid based on the plurality of clusters and a tree-based technique. In an embodiment, the tree-based technique is one of, not limited to, XGboost technique or HistGBR technique. In addition to the non-linear models (i.e., HistGBR and XGBoost) which captures more complex, non-linear relationship, a piecewise linear regression may be used as a base model to create multiple models for every range and combine them together to create a single model using ensemble learning in such a way that the single model itself is capable of predicting for different turbidity ranges and/or at least one parameter related to turbidity 145. The at least one parameter related to turbidity 145 comprises at least one of a turbidity value, consistency, and total suspended solids value of the liquid.

In the embodiment, where the measuring module is positioned externally, such that it is not part of the probe, the measuring module may reside on a server 123 operatively coupled to the probe or be implemented on an electronic device operatively coupled to the probe. The server 123 may be a cloud-based server. The electronic device may be, not limited to, a mobile device, or a laptop, or a computer system. The packetization module 121 of the electronic circuit segments the digital data of each dedicated channel of the at least two pairs of detectors 109 into associated plurality of packets for each dedicated channel. The packetization of the digital data involves segmenting the digital data into smaller units called packets. Each packet contains both actual data and essential metadata. Thereafter, the packetization module 121 of the electronic circuit transmits the associated plurality of packets of each dedicated channel of the at least two pairs of detectors 109 to the measuring module. The measuring module receives the associated plurality of packets of each dedicated channel of the at least two pairs of detectors 109 from the packetization module 121 of the electronic circuit. Thereafter, the measuring module extracts the digital data 115 from the associated plurality of packets for each channel (i.e., five means created for each channel 139) and segregates the digital data 115 into a plurality of clusters using a clustering technique (i.e., model applied on the processed data 141), and measure or estimate at least one parameter related to turbidity 145 of the liquid based on the plurality of clusters and a tree-based technique. In an embodiment, the clustering technique is, not limited to, a K-means clustering technique. The measuring module of the probe measures at least one parameter related to turbidity 145 of the liquid based on the plurality of clusters and a tree-based technique. In an embodiment, the tree-based technique is one of, not limited to, XGboost technique or HistGBR technique. The at least one parameter related to turbidity 145 comprises at least one of a turbidity value, consistency, and total suspended solids value of the liquid. In detail, from the measured turbidity value, the TSS can be derived using techniques known in the art, such as linear correlation or linear regression techniques established for specific liquid sample types. Once the TSS value has been determined, the consistency of the liquid sample can be obtained by applying the relationship described above in equation (1), which links TSS to consistency. In an embodiment, the output of the tree-based model may be averaged (i.e., average taken for last 30 predictions 143) to measure or estimate the at least one of a turbidity value, consistency, and total suspended solids value in the liquid (i.e., turbidity value 145). The foregoing method for measuring at least one parameter related to the turbidity of a liquid concludes the testing phase.

In some embodiments, the measuring module may be implemented as a dedicated hardware unit. As a dedicated hardware unit, the measuring module may be an application specific integrated circuit (ASIC), an electronic circuit, a field-programmable gate arrays (FPGA), programmable system-on-chip (PSoC), a combinational logic circuit, and/or other suitable components that provide the described functionality. The measuring module when configured with the functionality defined in the present disclosure will result in a novel hardware. In some embodiments, the measuring module may be implemented as a software application configured to execute on the server 123 or on the electronic device that is communicatively coupled to the microcontroller 117 of the electronic circuit for performing the above-mentioned functions.

Prior to using the K-means clustering technique and a tree-based technique during a testing phase, the K-means clustering technique and a tree-based technique may be trained using the digital data on the server 123 during a training phase. On the server 123, the digital data, which is noise-free, is processed using online cloud services 125. During training phase, the digital data is used to train a clustering technique and a tree-based technique.

Prior to the training phase, the associated plurality of packets are processed to extract the digital data for each channel (i.e., five mean values created for each channel 129) including cleaning the digital data (i.e., data cleaning 131). Thereafter, during the training phase, using the digital data, an array of 2500 elements or data are made from mean and Standard Deviations (SD) of each of the channels. This is taken completely from the ON state of the at least two emitters 103. When multiple spikes are detected in the digital data, the value of mean and SD are compared with the digital data and the lesser value among the mean, SD, and the digital data is chosen as the predicted value. The so formed data are segregated into a plurality of clusters (i.e., multiple clusters) through the clustering technique (i.e., K-means used for cluster centres 133). Subsequently, the plurality of clusters are processed using a tree-based model (i.e., XGboost or HistGBR model fitted for each clusters 135) to measure or estimate the at least one of a turbidity value, consistency, and total suspended solids value in the liquid (i.e., turbidity value 145) and sent to a user interface of the electronic device for display and/or analysis (i.e., model sent to Elixa 137).

During the testing phase, the data processing steps described with respect to the training phase are repeated in order to measure or estimate the at least one parameter related to turbidity comprises at least one of a turbidity value, consistency, and total suspended solids value of the liquid.

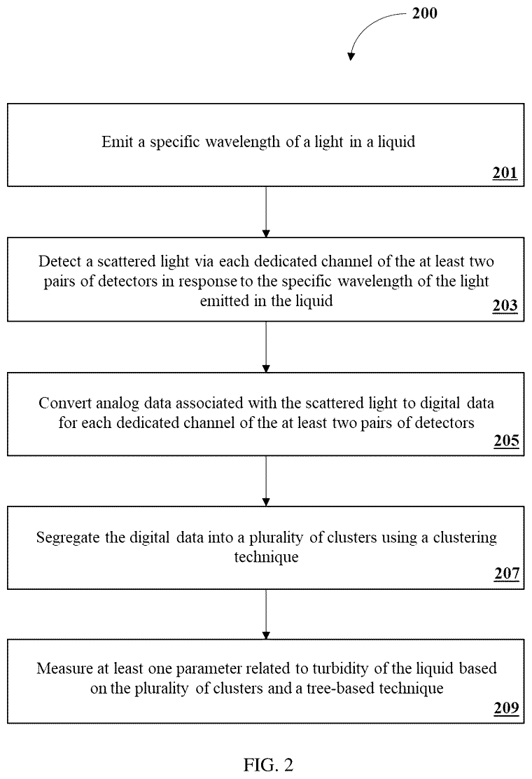

FIG. 2 illustrates a flow diagram showing a method for measuring turbidity, consistency, and total suspended solids in accordance with an embodiment of the present disclosure.

As illustrated in FIG. 2, the method 200 includes one or more blocks for measuring turbidity, consistency, and total suspended solids in accordance with an embodiment of the present disclosure. The method 200 may be described in the general context of computer executable instructions. Generally, computer executable instructions can include routines, programs, objects, components, data structures, procedures, modules, and functions, which perform particular functions or implement particular abstract data types.

The order in which the method 200 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 201, each emitter of the at least two emitters 103 of the probe emit a specific wavelength of a light in a liquid. The specific wavelength of the light is one of wavelengths from 800 nm to 1100 nm. The liquid comprises suspended particles.

At block 203, each detector of the at least two pairs of detectors 109 of the probe detect a scattered light via each dedicated channel of the at least two pairs of detectors 109 in response to the specific wavelength of the light emitted in the liquid. Each detector of the at least two pairs of detectors 109 is a photodiode.

At block 205, the electronic circuit of the probe converts analog data associated with the scattered light to digital data for each dedicated channel of the at least two pairs of detectors 109.

At block 207, the measuring module of the probe segregates the digital data into a plurality of clusters 133 using a clustering technique

At block 209, the measuring module of the probe measures at least one parameter related to turbidity 145 of the liquid based on the plurality of clusters and a tree-based technique. The at least one parameter related to turbidity 145 comprises at least one of a turbidity value, consistency, and total suspended solids value of the liquid.

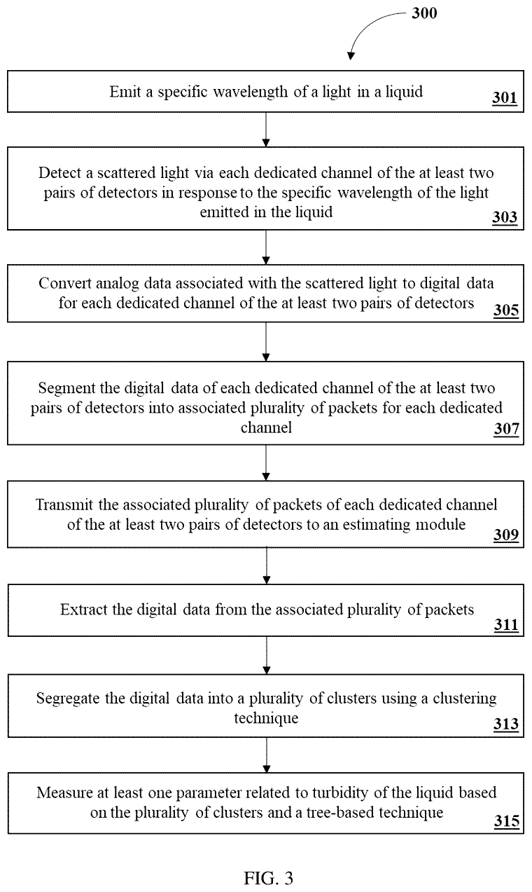

FIG. 3 illustrates a flow diagram showing a method for measuring turbidity, consistency, and total suspended solids in accordance with another embodiment of the present disclosure.

As illustrated in FIG. 3, the method 300 includes one or more blocks for measuring turbidity, consistency, and total suspended solids in accordance with another embodiment of the present disclosure. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, each emitter of the at least two emitters 103 of the probe emit a specific wavelength of a light in a liquid. The specific wavelength of the light is one of wavelengths from 800 nm to 1100 nm. The liquid comprises suspended particles.

At block 303, each detector of the at least two pairs of detectors 109 of the probe detect a scattered light via each dedicated channel of the at least two pairs of detectors 109 in response to the specific wavelength of the light emitted in the liquid. Each detector of the at least two pairs of detectors 109 is a photodiode.

At block 305, the electronic circuit of the probe converts analog data associated with the scattered light to digital data for each dedicated channel of the at least two pairs of detectors 109.

At block 307, the electronic circuit of the probe segments the digital data of each dedicated channel of the at least two pairs of detectors 109 into associated plurality of packets for each dedicated channel.

At block 309, the electronic circuit of the probe transmits the associated plurality of packets of each dedicated channel of the at least two pairs of detectors 109 to a measuring module.

At block 311, the measuring module extracts the digital data from the associated plurality of packets.

At block 313, the measuring module segregates the digital data into a plurality of clusters 133 using a clustering technique.

At block 315, the measuring module measures at least one parameter related to turbidity 145 of the liquid based on the plurality of clusters and a tree-based technique. The at least one parameter related to turbidity 145 comprises at least one of a turbidity value, consistency, and total suspended solids value of the liquid.

Some of the technical advantages of the present disclosure are listed below.

The electronic circuit along with the measuring module of the turbidity sensor system of the present disclosure streamlines the process of collecting data from the detectors. This approach allows the turbidity sensor system of the present disclosure to produce fast responses with minimum processing time delay.

The electronic circuit along with the measuring module of the turbidity sensor system of the present disclosure overcomes processing complications that typically exist with sensors having in-built processing circuitry. The absence of sensor with in-built analog processing circuitry in the present disclosure makes the turbidity sensor system less complicated in terms of analogue processing circuitry, less space-consuming, and efficient.

The electronic circuit processes and filters the signals associated with scattered light detected via each dedicated channel of the at least two pairs of detectors, thereby generating noise-free data. The electronic circuit subsequently converts the filtered analog signals into digital data for each dedicated channel. This configuration provides the technical advantage of minimizing the influence of noise on the measurement signals, thereby enhancing data integrity, improving accuracy of turbidity-related parameter estimation, and ensuring reliable turbidity sensor system performance.

The inclusion of at least two pairs of detectors, corresponding to four photodiodes, within the probe of the turbidity sensor system provides multiple independent detection channels for scattered light. By enabling acquisition of extensively scattered light data across distinct channels, the turbidity sensor system achieves enhanced signal resolution and directional bias. This configuration improves measurement accuracy and reliability, thereby facilitating precise determination/measurement of at least one of a turbidity value, consistency, and total suspended solids value of the liquid.

From the measured turbidity value, the TSS can be derived using techniques known in the art, such as linear correlation or linear regression techniques established for specific liquid sample types. Once the TSS value has been determined, the consistency of the liquid sample can be obtained by applying the relationship described above in equation (1), which links TSS to consistency. This approach allows indirect estimation of consistency through turbidity measurements, thereby reducing the need for direct consistency testing and enabling more efficient monitoring of process parameters.

By integrating consistency, TSS, and turbidity measurements, the present invention establishes a comprehensive framework for monitoring pulp suspensions. Consistency ensures fibre concentration control, TSS provides a total solids benchmark, and turbidity offers optical feedback on fines and colloidal content. Together, these parameters enable more precise process regulation, improved quality assurance, and enhanced adaptability in industrial pulp and paper applications.

Some of the clauses are mentioned below.

[1]: A turbidity sensor system, comprising:
a probe suspended in a liquid, wherein the probe comprises:
   at least two emitters, wherein each emitter of the at least two emitters is configured to:
      emit a specific wavelength of a light in the liquid;
   at least two pairs of detectors, wherein each detector of the at least two pairs of detectors is configured to:
      detect a scattered light via each dedicated channel of the at least two pairs of detectors in response to the specific wavelength of the light emitted in the liquid;
   an electronic circuit communicatively connected to the at least two pairs of detectors, wherein the electronic circuit is configured to:
      convert analog data associated with the scattered light to digital data for each dedicated channel of the at least two pairs of detectors;
   a measuring module communicatively connected to the electronic circuit, wherein the measuring module is configured to:
      segregate the digital data into a plurality of clusters using a clustering technique; and
      measure at least one parameter related to turbidity of the liquid based on the plurality of clusters and a tree-based technique.
         [2] The turbidity sensor system as described in [1], wherein the probe further comprises:
a trigger circuit communicatively connected to the at least two emitters, wherein the trigger circuit is configured to:
   trigger one emitter of the at least two emitters to emit the specific wavelength of the light in the liquid.
      [3]: The turbidity sensor system as described in [2], wherein to trigger one emitter of the at least two emitters to emit the specific wavelength of the light in the liquid is such that only one emitter of the at least two emitters is in ON state during each cycle for a first period and each emitter of the at least two emitters is in OFF state for a second period.
      [4]: The turbidity sensor system as described in [1], wherein prior to converting the analog data to the digital data for each dedicated channel of the at least two pairs of detectors, the electronic circuit is configured to:
filter the analog data associated with the scattered light detected via each dedicated channel of the at least two pairs of detectors.
   [5]: The turbidity sensor system as described in [1], wherein each detector of the at least two pairs of detectors is a photodiode.
   [6]: The turbidity sensor system as described in [1], wherein the probe comprises a reference window and an optical window for each emitter of the at least two emitters, and each detector of the at least two pairs of detectors.
   [7]: The turbidity sensor system as described in [1], wherein the at least one parameter related to turbidity comprises at least one of a turbidity value, consistency, and total suspended solids value of the liquid.
   [8]: The turbidity sensor system as described in [1], wherein the specific wavelength of the light is one of wavelengths from 800 nm to 1100 nm.
   [9]: The turbidity sensor system as described in [1], wherein the liquid comprises suspended particles.
   [10]: A turbidity sensor system, comprising:
a probe suspended in a liquid, wherein the probe comprises:
   at least two emitters, wherein each emitter of the at least two emitters is configured to: emit a specific wavelength of a light in the liquid;
   at least two pairs of detectors, wherein each detector of the at least two pairs of detectors is configured to:
      detect a scattered light via each dedicated channel of the at least two pairs of detectors in response to the specific wavelength of the light emitted in the liquid;
   an electronic circuit communicatively connected to the at least two pairs of detectors, wherein the electronic circuit is configured to:
      convert analog data associated with the scattered light to digital data for each dedicated channel of the at least two pairs of detectors;
      segment the digital data of each dedicated channel of the at least two pairs of detectors into associated plurality of packets for each dedicated channel;
      transmit the associated plurality of packets of each dedicated channel of the at least two pairs of detectors to a measuring module; and
   the measuring module communicatively connected to the electronic circuit, wherein the measuring module is configured to:
      extract the digital data from the associated plurality of packets;
      segregate the digital data into a plurality of clusters using a clustering technique; and
      measure at least one parameter related to turbidity of the liquid based on the plurality of clusters and a tree-based technique.
         [11]: The turbidity sensor system as described in [10], wherein the probe further comprises:
a trigger circuit communicatively connected to the at least two emitters, wherein the trigger circuit is configured to:
   trigger one emitter of the at least two emitters to emit the specific wavelength of the light in the liquid.
      [12]: The turbidity sensor system as described in [11], wherein to trigger one emitter of the at least two emitters to emit the specific wavelength of the light in the liquid is such that only one emitter of the at least two emitters is in ON state during each cycle for a first period and each emitter of the at least two emitters is in OFF state for a second period.
      [13]: The turbidity sensor system as described in [10], wherein prior to converting the analog data to the digital data for each dedicated channel of the at least two pairs of detectors, the electronic circuit is configured to:
filter the analog data associated with the scattered light detected via each dedicated channel of the at least two pairs of detectors.
   [14]: The turbidity sensor system as described in [10], wherein each detector of the at least two pairs of detectors is a photodiode.
   [15]: The turbidity sensor system as described in [10], wherein the probe comprises a reference window and an optical window for each emitter of the at least two emitters, and each detector of the at least two pairs of detectors.
   [16]: The turbidity sensor system as described in [10], wherein the at least one parameter related to turbidity comprises at least one of a turbidity value, consistency, and total suspended solids value of the liquid.
   [17]: The turbidity sensor system as described in [10], wherein the specific wavelength of the light is one of wavelengths from 800 nm to 1100 nm.
   [18]: The turbidity sensor system as described in [10], wherein the liquid comprises suspended particles.
   [19]: A method for measuring at least one parameter related to turbidity of a liquid, the method comprising:
emitting a specific wavelength of a light in a liquid;
detecting a scattered light via each dedicated channel of the at least two pairs of detectors in response to the specific wavelength of the light emitted in the liquid;
converting analog data associated with the scattered light to digital data for each dedicated channel of the at least two pairs of detectors;
segregating the digital data into a plurality of clusters using a clustering technique; and
measuring at least one parameter related to turbidity of the liquid based on the plurality of clusters and a tree-based technique.
   [20]: The method as described in [19], wherein prior to emitting the specific wavelength of the light in the liquid, the method comprises:
triggering one emitter of the at least two emitters to emit the specific wavelength of the light in the liquid,
   wherein triggering one emitter of the at least two emitters to emit the specific wavelength of the light in the liquid is such that only one emitter of the at least two emitters is in ON state during each cycle for a first period and each emitter of the at least two emitters is in OFF state for a second period.
      [21]: The method as described in [20], wherein to trigger one emitter of the at least two emitters to emit the specific wavelength of the light in the liquid is such that only one emitter of the at least two emitters is in ON state during each cycle for a first period and each emitter of the at least two emitters is in OFF state for a second period.
      [22]: The method as described in [19], wherein prior to converting the analog data to the digital data for each dedicated channel of the at least two pairs of detectors, the method comprises:
filtering the analog data associated with the scattered light detected via each dedicated channel of the at least two pairs of detectors.
   [23]: The method as described in [19], wherein each detector of the at least two pairs of detectors is a photodiode.
   [24]: The method as described in [19], wherein the probe comprises a reference window and an optical window for each emitter of the at least two emitters, and each detector of the at least two pairs of detectors.
   [25]: The method as described in [19], wherein the at least one parameter related to turbidity comprises at least one of a turbidity value, consistency, and total suspended solids value of the liquid.
   [26]: The method as described in [19], wherein the specific wavelength of the light is one of wavelengths from 800 nm to 1100 nm.
   [27]: The method as described in [19], wherein the liquid comprises suspended particles.
   [28]: A method for measuring at least one parameter related to turbidity of a liquid, the method comprising:
emitting a specific wavelength of a light in the liquid;
detecting a scattered light via each dedicated channel of the at least two pairs of detectors in response to the specific wavelength of the light emitted in the liquid;
converting analog data associated with the scattered light to digital data for each dedicated channel of the at least two pairs of detectors;
segmenting the digital data of each dedicated channel of the at least two pairs of detectors into associated plurality of packets for each dedicated channel;
transmitting the associated plurality of packets of each dedicated channel of the at least two pairs of detectors to an estimating measuring module;
extracting the digital data from the associated plurality of packets;
segregating the digital data into a plurality of clusters using a clustering technique; and
measuring at least one parameter related to turbidity of the liquid based on the plurality of clusters and a tree-based technique.
   [29]: The method as described in [28], wherein prior to emitting the specific wavelength of the light in the liquid, the method comprises:
triggering one emitter of the at least two emitters to emit the specific wavelength of the light in the liquid,
   wherein triggering one emitter of the at least two emitters to emit the specific wavelength of the light in the liquid is such that only one emitter of the at least two emitters is in ON state during each cycle for a first period and each emitter of the at least two emitters is in OFF state for a second period.
      [30]: The method as described in [29], wherein to trigger one emitter of the at least two emitters to emit the specific wavelength of the light in the liquid is such that only one emitter of the at least two emitters is in ON state during each cycle for a first period and each emitter of the at least two emitters is in OFF state for a second period.
      [31]: The method as described in [28], wherein prior to converting the analog data to the digital data for each dedicated channel of the at least two pairs of detectors, the method comprises:
filtering the analog data associated with the scattered light detected via each dedicated channel of the at least two pairs of detectors.
   [32]: The method as described in [28], wherein each detector of the at least two pairs of detectors is a photodiode.
   [33]: The method as described in [28], wherein the probe comprises a reference window and an optical window for each emitter of the at least two emitters, and each detector of the at least two pairs of detectors.
   [34]: The method as described in [28], wherein the at least one parameter related to turbidity comprises at least one of a turbidity value, consistency, and total suspended solids value of the liquid.
   [35]: The method as described in [28], wherein the specific wavelength of the light is one of wavelengths from 800 nm to 1100 nm.
   [36]: The method as described in [28], wherein the liquid comprises suspended particles.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used herein, the term unit may be implemented in hardware and/or in software. If the unit is implemented in hardware, the unit may be configured as a device, e.g., as a computer or as a processor or as a part of a system, e.g., a computer system. If the unit is implemented in software, the unit may be configured as a computer program product, as a function, as a routine, or as a program code.

One or more computer-readable storage media may be utilized in implementing embodiments consistent with the present disclosure. A computer-readable storage medium refers to any type of physical memory on which a software (program) readable by an information processing apparatus may be stored. The information processing apparatus includes a processor and a memory, and the processor executes a process of the software. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, CD ROMs, DVDs, flash drives, disks, and any other known physical storage media.

The hardware used to implement the various illustrative logics, logical blocks, modules, and circuits described in connection with the aspects disclosed herein may include a general purpose processor, a Digital Signal Processor (DSP), a special-purpose processor such as an Application Specific Integrated Circuit (ASIC) or a Field Programmable Gate Array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, or additionally, some steps or methods may be performed by circuitry that is specific to a given function.

In one or more example embodiments, the functions described herein may be implemented by special-purpose hardware or a combination of hardware programmed by firmware or other software. In implementations relying on firmware or other software, the functions may be performed as a result of execution of one or more instructions stored on one or more non-transitory computer-readable media and/or one or more non-transitory processor-readable media. These instructions may be embodied by one or more processor-executable software modules that reside on the one or more non-transitory computer-readable or processor-readable storage media. Non-transitory computer-readable or processor-readable storage media may in this regard comprise any storage media that may be accessed by a computer or a processor. By way of example but not limitation, such non-transitory computer-readable or processor-readable media may include Random Access Memory (RAM), Read-Only Memory (ROM), Electrically Erasable Programmable Read-Only Memory (EEPROM), FLASH memory, disk storage, magnetic storage devices, or the like. Disk storage, as used herein, includes Compact Disc (CD), laser disc, optical disc, Digital Versatile Disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media may be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

### REFERRAL NUMERALS

| Reference | |
|---|---|
| number | Description |
| 100 | Environment or turbidity sensor system |
| 101 | Trigger circuit or timer |
| 103 | IR LED or plurality of IR LEDs or at least two emitters |
| 105 | Infrared emission |
| 107 | Scattered light |
| 109 | 4 Photodiodes or at least two pairs of detectors |
| 111 | 4 channel analog signal |
| 113 | Analog front end (AFE) |
| 115 | Analog to digital conversion or Digital data |
| 117 | Microcontroller |
| 119 | Data processing |
| 121 | Packetisation or packetization module |
| 123 | Server |
| 125 | Online cloud services |
| 127 | AFE configuration |
| 129, 139 | Five means created for each channel |
| 131 | Data cleaning |
| 133 | Clustering or K-means used for cluster centers |
| 135 | XGboost model fitted for each cluster or training tree-based |
| | technique |
| 137 | Transmission of tree-based technique or model sent to |
| | measuring module |
| 141 | Measuring or model applied on the processed data |
| 143 | Averaging or average taken for last 30 predictions |
| 145 | Turbidity value or at least one parameter related to turbidity |
| | of the liquid |
| 151 | Optical window 1 for Emitter 1 |
| 153 | Optical window 2 for Emitter 2 |
| 155 | Optical window 3 for Detector 1 associated with Emitter 1 |
| 157 | Optical window 4 for Detector 2 associated with Emitter 1 |
| 159 | Optical window 5 for Detector 3 associated with Emitter 2 |
| 161 | Optical window 6 for Detector 4 associated with Emitter 2 |
| 163 | Optical window 7 for reference window |

What is claimed is:

1. A turbidity sensor system, comprising:
a probe suspended in a liquid, wherein the probe comprises:
at least two emitters, wherein each emitter of the at least two emitters is configured to:
emit a specific wavelength of a light in the liquid;
at least two pairs of detectors, wherein each detector of the at least two pairs of detectors is configured to:
detect a scattered light via each dedicated channel of the at least two pairs of detectors in response to the specific wavelength of the light emitted in the liquid;
an electronic circuit communicatively connected to the at least two pairs of detectors, wherein the electronic circuit is configured to:
convert analog data associated with the scattered light to digital data for each dedicated channel of the at least two pairs of detectors;
a measuring module communicatively connected to the electronic circuit, wherein the measuring module is configured to:
segregate the digital data into a plurality of clusters using a clustering technique; and
measure at least one parameter related to turbidity of the liquid based on the plurality of clusters and a tree-based technique.

2. The turbidity sensor system of claim 1, wherein the probe further comprises:
a trigger circuit communicatively connected to the at least two emitters, wherein the trigger circuit is configured to:
trigger one emitter of the at least two emitters to emit the specific wavelength of the light in the liquid.

3. The turbidity sensor system of claim 2, wherein to trigger one emitter of the at least two emitters to emit the specific wavelength of the light in the liquid is such that only one emitter of the at least two emitters is in ON state during each cycle for a first period and each emitter of the at least two emitters is in OFF state for a second period.

4. The turbidity sensor system of claim 1, wherein prior to converting the analog data to the digital data for each dedicated channel of the at least two pairs of detectors, the electronic circuit is configured to:
filter the analog data associated with the scattered light detected via each dedicated channel of the at least two pairs of detectors.

5. The turbidity sensor system of claim 1, wherein each detector of the at least two pairs of detectors is a photodiode.

6. The turbidity sensor system of claim 1, wherein the probe comprises a reference window and an optical window for each emitter of the at least two emitters, and each detector of the at least two pairs of detectors.

7. The turbidity sensor system of claim 1, wherein the at least one parameter related to turbidity comprises at least one of a turbidity value, consistency, and total suspended solids value of the liquid.

8. The turbidity sensor system of claim 1, wherein the specific wavelength of the light is one of wavelengths from 800 nm to 1100 nm.

9. The turbidity sensor system of claim 1, wherein the liquid comprises suspended particles.

10. A turbidity sensor system, comprising:
a probe suspended in a liquid, wherein the probe comprises:
at least two emitters, wherein each emitter of the at least two emitters is configured to:
emit a specific wavelength of a light in the liquid;
at least two pairs of detectors, wherein each detector of the at least two pairs of detectors is configured to:
detect a scattered light via each dedicated channel of the at least two pairs of detectors in response to the specific wavelength of the light emitted in the liquid;
an electronic circuit communicatively connected to the at least two pairs of detectors, wherein the electronic circuit is configured to:
convert analog data associated with the scattered light to digital data for each dedicated channel of the at least two pairs of detectors;
segment the digital data of each dedicated channel of the at least two pairs of detectors into associated plurality of packets for each dedicated channel;
transmit the associated plurality of packets of each dedicated channel of the at least two pairs of detectors to a measuring module; and
the measuring module communicatively connected to the electronic circuit, wherein the measuring module is configured to:
extract the digital data from the associated plurality of packets;
segregate the digital data into a plurality of clusters using a clustering technique; and
measure at least one parameter related to turbidity of the liquid based on the plurality of clusters and a tree-based technique.

11. The turbidity sensor system of claim 10, wherein the probe further comprises:
a trigger circuit communicatively connected to the at least two emitters, wherein the trigger circuit is configured to:
trigger one emitter of the at least two emitters to emit the specific wavelength of the light in the liquid.

12. The turbidity sensor system of claim 11, wherein to trigger one emitter of the at least two emitters to emit the specific wavelength of the light in the liquid is such that only one emitter of the at least two emitters is in ON state during each cycle for a first period and each emitter of the at least two emitters is in OFF state for a second period.

13. The turbidity sensor system of claim 10, wherein prior to converting the analog data to the digital data for each dedicated channel of the at least two pairs of detectors, the electronic circuit is configured to:
filter the analog data associated with the scattered light detected via each dedicated channel of the at least two pairs of detectors.

14. The turbidity sensor system of claim 10, wherein each detector of the at least two pairs of detectors is a photodiode.

15. The turbidity sensor system of claim 10, wherein the probe comprises a reference window and an optical window for each emitter of the at least two emitters, and each detector of the at least two pairs of detectors.

16. The turbidity sensor system of claim 10, wherein the at least one parameter related to turbidity comprises at least one of a turbidity value, consistency, and total suspended solids value of the liquid.

17. The turbidity sensor system of claim 10, wherein the specific wavelength of the light is one of wavelengths from 800 nm to 1100 nm.

18. The turbidity sensor system of claim 10, wherein the liquid comprises suspended particles.

19. A method for measuring at least one parameter related to turbidity of a liquid, the method comprising:
emitting a specific wavelength of a light in a liquid;
detecting a scattered light via each dedicated channel of at least two pairs of detectors in response to the specific wavelength of the light emitted in the liquid;
converting analog data associated with the scattered light to digital data for each dedicated channel of the at least two pairs of detectors;
segregating the digital data into a plurality of clusters using a clustering technique; and
measuring at least one parameter related to turbidity of the liquid based on the plurality of clusters and a tree-based technique.

20. The method of claim 19, wherein prior to emitting the specific wavelength of the light in the liquid, the method comprises:
triggering one emitter of at least two emitters to emit the specific wavelength of the light in the liquid,
wherein triggering one emitter of the at least two emitters to emit the specific wavelength of the light in the liquid is such that only one emitter of the at least two emitters is in ON state during each cycle for a first period and each emitter of the at least two emitters is in OFF state for a second period.
